(19) United States
(12) Patent Application Publication
(10) Pub. No.: US 2008/0154605 A1
(43) Pub. Date: Jun. 26, 2008

(54) ADAPTIVE QUALITY ADJUSTMENTS FOR SPEECH SYNTHESIS IN A REAL-TIME SPEECH PROCESSING SYSTEM BASED UPON LOAD

(75) Inventor: KENNETH H. MORGAN, BOCA RATON, FL (US)

Correspondence Address: PATENTS ON DEMAND, P.A., 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 11/614,286

(22) Filed: Dec. 21, 2006

(51) Int. Cl. G10L 13/00

(52) U.S. Cl. 704/258; 704/E21.02

(57) ABSTRACT

The present invention discloses a solution that dynamically adapts quality settings of a real-time speech synthesis system based upon load, which results in a proportional change in consumed resources. For example, when quantity of available CPU cycles is low, a quality of speech can be automatically lowered. When a quantity of available CPU cycles is high, a quality of speech can be automatically increased. Accordingly, the solution discloses an adaptive speech synthesis system that provides a highest possible quality of speech in a real-time environment experiencing rapid changes in request volume and/or complexity.

### BACKGROUND

1. Field of the Invention

The present invention relates to the field of speech processing, and, more particularly, to a real-time speech processing system that makes adaptive quality adjustments for generated speech based upon load.

2. Description of the Related Art

Speech processing operations can vary dramatically in terms of quality and resource consumption. For example, small and minimally complex speech synthesis systems, which are often based upon formant synthesis techniques, are able to execute upon resource-constrained devices, such as mobile phones and navigational devices. More complex speech synthesis operations, such as synthesis involving concatenation, often consume tremendous server resources to produce a natural sounding speech, which is pleasing to a listener. In general, the quality of synthesized speech can be proportionally related to the quantity of computing resources, such as processor cycles, consumed.

For example, formant synthesis is generally less resource consuming than concatenation synthesis. Regardless of a type of synthesis being performed, certain digital signal processing (DSP) algorithms can produce better results than others at a cost of greater resource consumption. Optional filtering and smoothing processes can also increase speech output quality, but incur an additional processing cost. Further, the complexity of processing for concatenation speech synthesis systems can depend upon a sampling quality of phonemes for the text-to-speech (TTS) synthesized voice, the quantity of voices used, and related variables. High quality (greater audio fidelity) component phonemes can require a significant increase in resources required for DSP compared to lower fidelity counterparts, which may still produce reasonable speech synthesis results.

All known speech synthesis systems operate at a constant level of speech quality, which requires these systems to have a sufficient quantity of computing resources available to handle their highest possible load, even if such a load rarely occurs. This is unfortunate for system owners as speech processing hardware/software can be extremely expensive. A relative premium is being paid for a last portion of optimal functionality. That is, a system configured to function optimally ninety percent of the time at a normal load could cost much less than a system that is configured to handle the maximum expected load.

What is needed is a speech processing system that can automatically adjust the quality of real-time speech synthesis based upon load and available system resources. Ideally, such a solution would modify speech synthesis settings to alter speech quality responsive to the workload and computing resources available for speech synthesis. That is, the synthesized speech could decrease in quality under conditions of low resource availability and/or high load and could increase when resources become available and/or the load decreases.

### SUMMARY OF THE INVENTION

The present invention discloses a solution that dynamically adapts quality settings of a real-time speech synthesis system based upon load, which results in a proportional change in consumed resources. For example, when quantity of available CPU cycles is low, a quality of speech can be automatically lowered. When a quantity of available CPU cycles is high, a quality of speech can be automatically increased. Accordingly, the solution discloses an adaptive speech synthesis system that provides a highest possible quality of speech in a real-time environment experiencing rapid changes in request volume and/or complexity.

For example, the solution can be implemented in an automated speech-enabled traffic server, which is subject to extreme caller volume during adverse weather conditions. This solution provides a means of preventing overload without requiring a speech synthesis system be over designed so that rarely occurring periods of high load are able to be handled. Instead, the solution provides a means where quality can experience graceful degradation during periods of extreme activity to maximum usage of available resources.

The present invention can be implemented in accordance with numerous aspects consistent with the material presented herein. For example, one aspect of the present invention can include a method for optimally handling load/quality tradeoffs in a speech synthesis system. The method can include a step of determining a current quantity of computing resources available to a speech synthesis system. The determined quantity can be compared to at least one previously established threshold. Depending upon results of the comparing step, a quality setting can be automatically adjusted relating to a quality of speech produced by the speech synthesis system. A change in the quality setting results in a corresponding resource consumption change.

Another aspect of the present invention can include an adaptive method for generating speech. The method can automatically determine a level of resources utilized by a speech synthesis system. Settings of the speech synthesis system can be automatically adjusted that affect a quality of generated speech. Changing the settings automatically results in a resource usage level change. When the level is relatively high, the settings can be automatically adjusted to lower a quality of generated speech, which lowers a rate of resource consumption. When the level is relatively low, the settings can be automatically adjusted to increase a quality of generated speech, which increases a resource consumption rate. The steps of the method can be iteratively repeated in real-time so that the speech synthesis system is continuously being adapted based on load.

Still another aspect of the present invention can include a system for generating speech that includes a speech synthesis engine, a resource monitor, and a settings adjustor. The speech synthesis engine can generate speech output in accordance with a set of adjustable settings. The resource monitor can determine quantities of resources that are available to the speech synthesis engine or quantities of resources that are utilized by the speech synthesis engine. The settings adjustor can dynamically adjust a set of the adjustable settings to vary a quality of speech output produced by the speech synthesis engine, which results in a corresponding change in quantities of resources consumed. These settings can be automatically changed by the settings adjustor based upon a resource usage and/or resource availability level, as determined by the resource monitor.

It should be noted that various aspects of the invention can be implemented as a program for controlling computing equipment to implement the functions described herein, or a program for enabling computing equipment to perform processes corresponding to the steps disclosed herein. This program may be provided by storing the program in a magnetic disk, an optical disk, a semiconductor memory, or any other recording medium. The program can also be provided as a digitally encoded signal conveyed via a carrier wave. The described program can be a single program or can be implemented as multiple subprograms, each of which interact within a single computing device or interact in a distributed fashion across a network space.

It should also be noted that the methods detailed herein can also be methods performed at least in part by a service agent and/or a machine manipulated by a service agent in response to a service request.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram of a system in which a speech processing system can adapt speech synthesis operations based on resource and load quantities in accordance with an embodiment of the inventive arrangements disclosed herein.

FIG. 2 is an interactive flow illustrating the separate, yet, related processes of resource adjustment and speech synthesis in accordance with an embodiment of the inventive arrangements disclosed herein.

FIG. 3 is a flow chart of a method outlining a resource-adaptive speech synthesis algorithm in accordance with an embodiment of the inventive arrangements disclosed herein.

FIG. 4 is a flow chart of a method where a service agent can configure a speech processing system to adapt speech synthesis quality based upon load and/or available resources in accordance with an embodiment of the inventive arrangements disclosed herein.

### DETAILED DESCRIPTION OF THE INVENTION

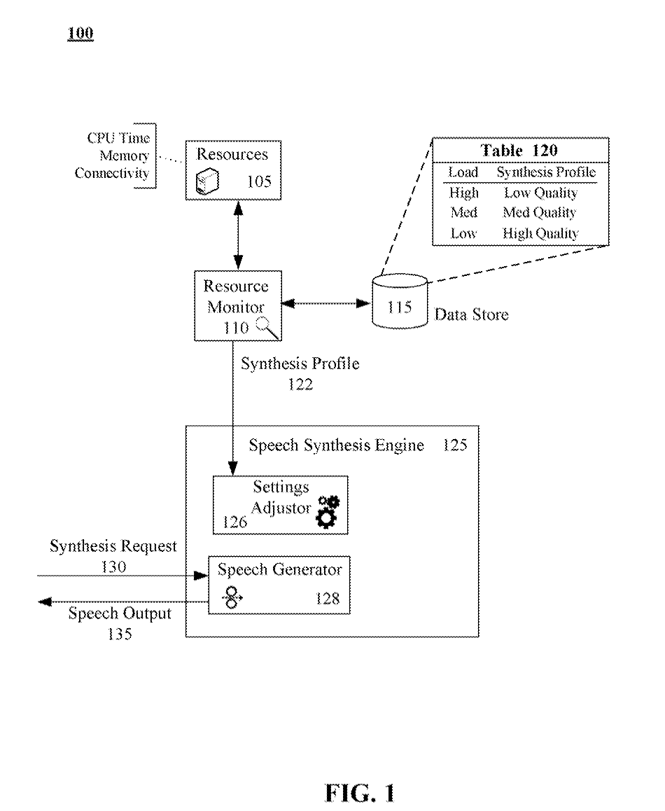

FIG. 1 is a schematic diagram of a system 100 in which a speech synthesis engine 125 can adapt speech synthesis operations based on resource and load quantities in accordance with an embodiment of the inventive arrangements disclosed herein. In system 100, the amount of available system resources 105 can be checked by a resource monitor 110.

The resources 105 can include a variety of computing resources available to the speech synthesis engine 125 to produce speech output 135, such as CPU time or cycles, memory, and connectivity throughput or bandwidth. Although shown as centrally located, the resources 105 can be distributed across a network or component space. It should be noted that the resources 105 available can be dependent upon the overall system implementation containing the speech processing engine 125. For example, connectivity throughput may not be a consideration in a stand-alone system, but can be an important bottleneck in a system where the engine 125 is a network element.

The resource monitor 110 can be a software application that can determine the amount of available resources 105. The resource monitor 110 can access a data store 115 to compare the determined resource amounts against values in a table 120. It should be noted that the table 120 can be a single table containing various combinations of resource and/or load values and an associated synthesis profile or a series of tables containing such information. As shown in this simplified example, table 120 contains data that relates the quality of speech synthesis to the load being experienced by the system.

From this information, the resource monitor 110 can determine which synthesis profile 122 is applicable to the current operating conditions. This determination can include additional logic to resolve situations where multiple profiles can be applicable, based on the complexity and implementation of the system. The synthesis profile 122 can be sent to the settings adjustor 126 of the speech synthesis engine 125.

The settings adjustor 126 can modify the synthesis settings of the speech synthesis engine 125. For example, when the system is experiencing a high load, the adjustor 126 can receive values in the synthesis profile 122 that reduce the quality of the synthesized speech output 135. When the speech generator 128 receives a synthesis request 130, the speech generator 130 can use the current settings to generate the speech output 135. It should be appreciated that the monitoring of resources and adjusting of synthesis settings based on resource levels can occur automatically, dynamically, and in tandem with speech generation.

A myriad of settings can be manipulated by the settings adjustor 126, each representing a quality/resource consumption trade-off. For example, a different type of synthesis (such as concatenative or formant) can be selected based upon load. Different algorithms can also be used, some more computationally expensive than others. Further, optional algorithms, such as output smoothing DSP algorithms can be deactivated in a resource saving mode and can be activated in a quality enhancement mode.

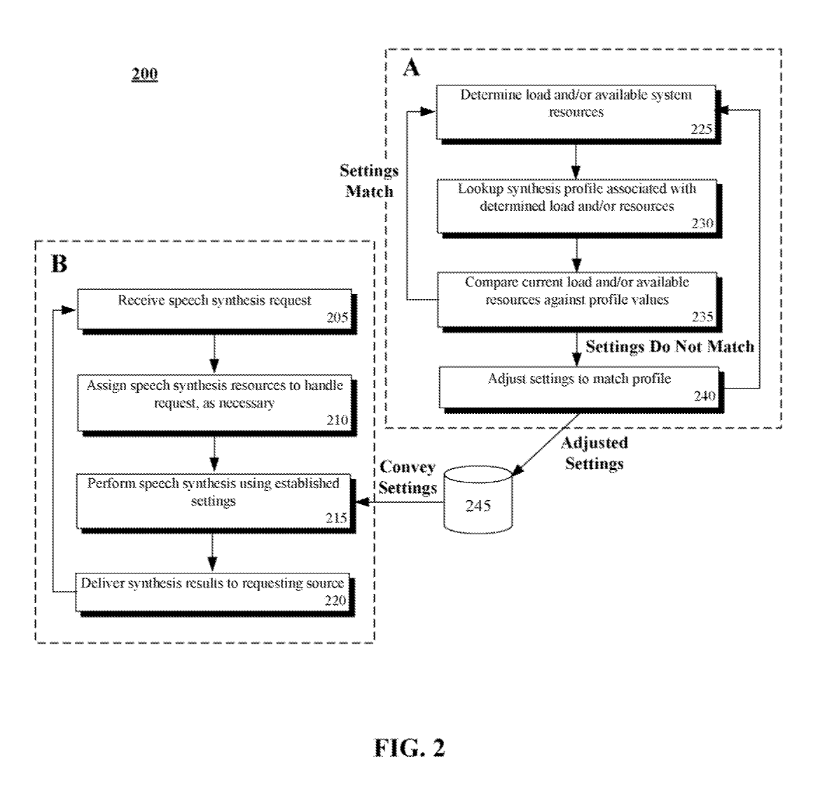

FIG. 2 is an interactive flow 200 illustrating the separate, yet related processes of resource adjustment and speech synthesis in accordance with an embodiment of the inventive arrangements disclosed herein. The interactive flow 200 can be performed in the context of a system 100.

The interactive flow 200 can include two separate flows—A and B. Although flow A and flow B function separately, data produced by flow A can influence the performance of flow B. Additionally, flow A can continue to perform iterations even when flow B is inactive.

Flow A can begin with step 225 where the load and/or available system resources can be determined. In step 230, a synthesis profile associated with the determined load and/or resources can be looked up. The current load and/or available resources can be compared against the profile values in step 235. If settings in the profile match the current values, then it can be ascertained that the system is performing at the appropriate level and the flow can return to step 225 to continue monitoring the system for changes.

When the current values do not match the profile settings, the settings can be adjusted to match those of the profile in step 240. The adjusted settings can be stored in a data store 245, for use by flow B, and the flow can return to step 225 to continue monitoring the system for changes.

Flow B can begin in step 205, where the system can receive a speech synthesis request. In step 210, speech synthesis resources can be assigned to handle the request, as necessary. Speech synthesis can be performed using established settings in step 215. The established settings used in step 215 can be those stored in data store 245 by flow A. The synthesis results of step 215 can be delivered to the requesting source in step 220. Flow B can then repeat by returning to step 205.

It should be appreciated that in other implementations, the two flows A and B can be more tightly coupled than shown in method 200. For example, output from flow B can be analyzed to indicate a level of resource consumption. For instance, if the load on a speech synthesis system is too high, a rate of produced speech can automatically decrease and/or speech output can be presented in bursts or in a non-smooth fashion. Other similar resource overloading indicators can be determined by analyzing output produced by a speech processing system. When a fine grained control of adaptive quality settings is desired, resource determinations based upon factors other than a basic output analysis can be required.

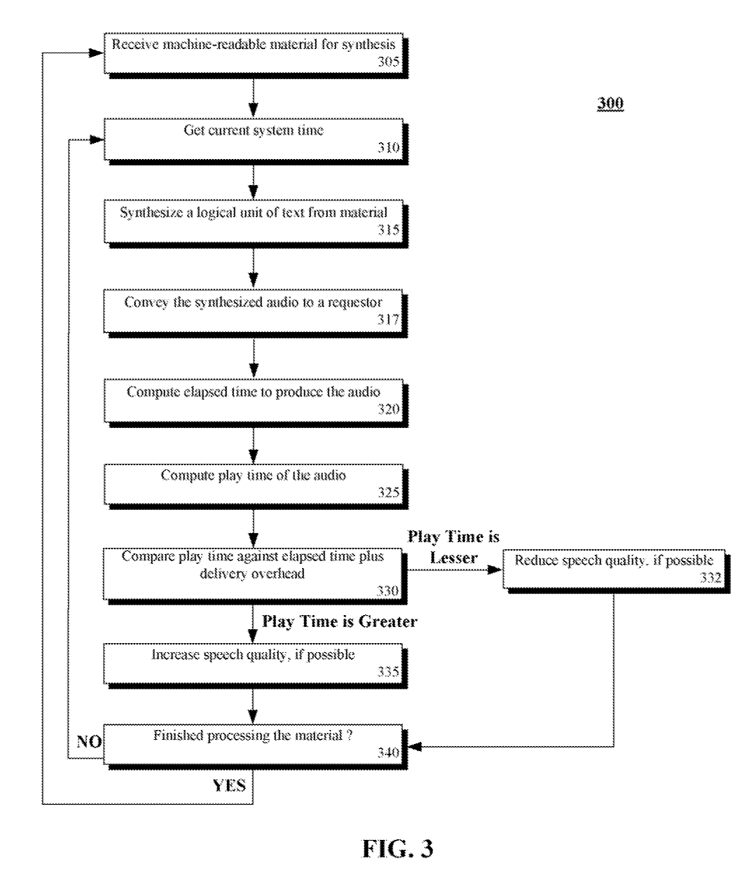

FIG. 3 is a flow chart of a method 300 outlining a resource-adaptive speech synthesis algorithm in accordance with an embodiment of the inventive arrangements disclosed herein. Method 300 can be performed in the context of system 100 and/or method 200.

Method 300 can begin with step 305, where the system can receive machine-readable material for synthesis. In step 310, the current system time can be obtained. A logical unit of text can be synthesized from the received material in step 315. Synthesized audio can be conveyed to the requestor in step 317. In step 320, the elapsed time to produce the audio for the logical unit can be computed. The play time of the audio can be computed in step 325.

In step 330, the computed play time can be compared against the computed elapsed time plus the delivery overhead. This comparison can determine if the system is able to produce a continuous stream of speech for its clients. Delivery overhead can include resource consumption and any additional time spent waiting for resources.

When the play time is less than the elapsed time plus delivery overhead, step 332 can be executed. In step 332, the speech quality can be reduced, if possible. When the play time is greater than the elapsed time plus delivery overhead, flow proceeds to step 335 where the speech quality can be increased, if possible.

For example, in one embodiment, speech output can be remotely generated and streamed to a presentation device after being cached. When the cached packets are consistently received before being needed, the speech synthesis system can likely be adjusted to produce higher quality output using available resources. That is, rapid packet creation and conveyance can be a good indicator that the speech synthesis system is under a relatively low load.

Both step 332 and step 335 proceed to step 340 where a check for remaining, unprocessed, logical units still existing in the received material can be made. If the entire received material has not been synthesized, the method can loop from step 340 to step 310, where the current system time is obtained again and the next logical unit of text included in the material can be handled. If no remaining portions of the received material require processing, the method can loop from step 340 to step 305, where new material for synthesis can be received.

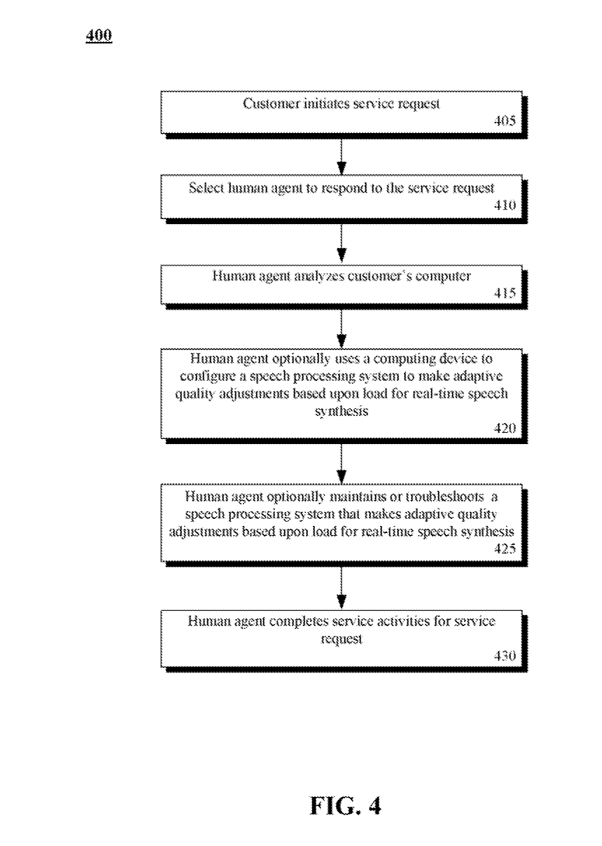

FIG. 4 is a flow chart of a method 400 where a service agent can configure a speech processing system to adapt speech synthesis quality based upon load and/or available resources in accordance with an embodiment of the inventive arrangements disclosed herein. Method 400 can be performed in the context of system 100 and include methods 200 and 300.

Method 400 can begin in step 405, when a customer initiates a service request. The service request can be a request for a service agent to provide a customer with a new speech processing system that can adapt speech synthesis quality based upon load and/or available resources. The service request can also be for an agent to enhance an existing speech processing system with the capability to adapt speech synthesis quality based upon load and/or available resources. The service request can also be for a technician to troubleshoot a problem with an existing system.

In step 410, a human agent can be selected to respond to the service request. In step 415, the human agent can analyze a customer's current system and/or problem and can responsively develop a solution. In step 420, the human agent can use one or more computing devices to configure a speech processing system to adapt speech synthesis quality based upon load and/or available resources. This step can include the installation and configuration of a resource monitor and the creation of operational profiles.

In step 425, the human agent can optionally maintain or troubleshoot a speech processing system that adjusts speech synthesis quality based upon load and/or available resources. In step 430, the human agent can complete the service activities.

The present invention may be realized in hardware, software, or a combination of hardware and software. The present invention may be realized in a centralized fashion in one computer system or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. A method for optimally handling load/quality tradeoffs in a speech synthesis system comprising:
determining a current quantity of computing resources available to a speech synthesis system;
comparing the determined quantity to at least one previously established threshold; and
depending upon results of the comparing step, automatically adjusting at least one quality setting of the speech synthesis system, which results in a corresponding change in the current quantity.

2. The method of claim 1, wherein when the comparing step indicates the quantity of available resources is relatively small, the adjusted quality setting decreases a quality of generated speech; and wherein when the comparing step indicates the quantity of available resources is relatively large, the adjusted quality setting increases a quality of generated speech.

3. The method of claim 2, further comprising:
iteratively and automatically repeating the determining, comparing, and adjusting steps.

4. The method of claim 1, wherein the computing resources comprise at least one of a CPU resource, a memory resource, and a connectivity throughput resource.

5. The method of claim 1, wherein the quality setting comprises at least one of a setting that changes a speech synthesis type, a setting that changes a digital signal processing algorithm used, and a setting that adjusts at least one parameter of an algorithm used by the speech synthesis system.

6. The method of claim 1, further comprising:
based upon the determined quality, determining a current resource level; and
querying a relational table to determine a synthesis profile that corresponds to the determined resource level, said synthesis profile specifying the at least one quality setting used in the adjusting step.

7. The method of claim 1, wherein said steps of claim 1 are performed by at least one machine in accordance with at least one computer program having a plurality of code sections that are executable by the at least one machine.

8. The method of claim 1, wherein the steps of claim 1 are performed by at least one of a service agent and a computing device manipulated by the service agents, the steps being performed in response to a service request.

9. An adaptive method for generating speech comprising:
automatically determining a level of resources utilized by a speech synthesis system; and
automatically adjusting settings of the speech synthesis system that affect a quality of generated speech to change the level.

10. The method of claim 9, said adjusting step further comprising:
when the level is relatively high, automatically adjusting the settings to lower a quality of generated speech, which lowers the level.

11. The method of claim 9, said adjusting step further comprising:
when the level is relatively low, automatically adjusting the settings to increase a quality of generated speech, which raises the level.

12. The method of claim 9, further comprising:
iteratively repeating the determining and adjusting steps in real-time.

13. The method of claim 9, said adjusting step further comprising:
automatically adjusting a type of synthesis performed by the speech synthesis system.

14. The method of claim 9, said adjusting step further comprising:
changing at least one digital signal processing algorithm used by the speech synthesis system, wherein an algorithm changed to and an algorithm changed from are both included in a plurality of available algorithms that the speech synthesis system is able to selectively utilize, wherein said available algorithms are different algorithms used for a common type of synthesis.

15. The method of claim 9, wherein said steps of claim 9 are performed by at least one machine in accordance with at least one computer program having a plurality of code sections that are executable by the at least one machine.

16. A system for generating speech comprising:
a speech synthesis engine configured to generate speech output in accordance with a plurality of adjustable settings;
a resource monitor configured to determine quantities of resources that are available to the speech synthesis engine or quantities of resources that are utilized by the speech synthesis engine; and
a settings adjustor configured dynamically to adjust a set of the adjustable settings to vary a quality of speech output produced by the speech synthesis engine, which results in a corresponding change in the quantities of resources, wherein settings are automatically changed by the settings adjustor based upon the quantities determined by the resource monitor.

17. The system of claim 16, wherein the resource comprise a CPU resource.

18. The system of claim 16, wherein the resources comprise at least two of a CPU resource, a memory resource, and a connectivity throughput resource.

19. The system of claim 16, the set of adjustable settings comprises at least one of a setting that changes a speech synthesis type, a setting that changes a digital signal processing algorithm used for a common speech synthesis type, and a setting that adjusts at least one parameter of an algorithm used by the speech synthesis engine.

20. The system of claim 16, further comprising:
a data store storing a plurality of entries that relate a resource level to a synthesis profile, wherein the system automatically and repetitively determines a current resource level based upon the quantities of resources determined by the resource monitor, wherein a synthesis profile related to the current resource level becomes an active synthesis profile for the system, and wherein the settings adjustor determines the set of settings based upon the active synthesis profile.
